(19) United States
(12) Patent Application Publication
(10) Pub. No.: US 2017/0205547 A1
(43) Pub. Date: Jul. 20, 2017

(54) SECURITY ELEMENT HAVING A SUBWAVELENGTH GRATING

(71) Applicant: GIESECKE & DEVRIENT GMBH, München (DE)

(72) Inventor: Hans LOCHBIHLER, München (DE)

(21) Appl. No.: 15/327,825

(22) PCT Filed: Jul. 14, 2015
(86) PCT No.: PCT/EP2015/001443

§ 371 Date: Jan. 20, 2017

(30) Foreign Application Priority Data
Jul. 21, 2014 (DE) 10 2014 010 751.5

(51) Int. Cl. G02B 5/18; B42D 25/351; B42D 25/328; G02B 5/20; B42D 25/29

(52) U.S. Cl. CPC G02B 5/1809; G02B 5/1866; G02B 5/203; B42D 25/29; B42D 25/328; B42D 25/351

(57) ABSTRACT

A security element for manufacturing value documents has a dielectric substrate embedded in the substrate a first line grating structure of first grating ridges made of highly refractive dielectric or semi-metallic material, and a second line grating structure of second grating ridges, made of highly refractive dielectric or semi-metallic material, running along the longitudinal direction. The first grating ridges have respectively a first thickness, and the second line grating structure. The security element generates a color effect in transmissive viewing, and the first and the second thickness amount to at least 100 nm.

The invention relates to a security element for manufacturing value documents, such as bank notes, checks or the like, which has a line grating structure.

Security elements having periodic line gratings are known, for example from DE 102009012299 A1, DE 102009012300 A1 or DE 102009056933 A1. They can have color filter properties in the subwavelength region when the grating is so designed that resonance effects occur in the visible spectral region. Such color filter properties are known both for reflective and for transmissive subwavelength structures. Said structures have a strongly polarizing influence on the reflection or the transmission of an incident light ray. The color is relatively strongly dependent on angle in reflection or transmission of such subwavelength gratings. However, the color saturation is considerably weakened for said gratings when the incident light is unpolarized.

There is known a line grating having subwavelength structures which possesses angular-dependent color-filtering properties. The line grating possesses a rectangular profile made of a dielectric material. The horizontal surfaces are overlaid with a highly refractive dielectric. Above this structure there is likewise located a dielectric material, with the refractive indices of the grating substrate and of the cover material preferably being identical. As a result there is formed an optically active structure consisting of two gratings made of the highly refractive material which are spaced by the height of the original rectangular profile. The grating ridges forming the line grating are made for example of zinc sulfide (ZnS). There can be produced therewith a color contrast in reflection, but in transmission a change of color tone for different angles is hardly perceptible. This structure is therefore only useful as a security feature in reflection and must be constructed on an absorbent base surface for that purpose.

One-dimensional periodic gratings can have color filter properties in the subwavelength region when the grating profile is so designed that resonance effects occur in the visible wavelength region. These color filter properties depend on the angle of the incident light.

DE 3248899 C2 describes a subwavelength structure having angular-dependent, color-filtering properties. This grating has in cross section a rectangular form and is vaporized with a highly refractive (HRI) layer, wherein for the refractive indices applies: n_{HRI}>n₂ and n₁≈n₂≈n₃. A color change occurs with a variation of the angle Θ. If the grating is tilted perpendicularly to the plane of incidence (Θ>0°; Φ=90°), the color remains approximately constant. The angle Φ designates the azimuth angle. The security element marketed under the name DID (“Diffractive Identification Device”) is based on this structure and makes use of the color filter properties in reflection. A light absorbent base surface is required to perceive a color effect.

The WO 2012/019226 A1 describes an embossed subwavelength grating likewise with a rectangular profile on whose plateau metal particles or metallic nanoparticles are imprinted. This grating shows coloring or polarization effects in transmission.

Further, subwavelength gratings are known as angular-dependent color filters, which have a metallic or semi-metallic bi layer arrangement, for example from the DE 102011115589 A1 or from Z. Ye et al., “Compact Color Filter and Polarizer of Bilayer Metallic Nanowire Grating Based on Surface Plasmon Resonances”, Plasmonics, 8, 555-559 (2012), wherein the metalization is realized by vapor deposition and is embedded into a dielectric. The approach described in DE 102011115589 A1 is based on an arrangement of two wire gratings with the same period, which are displaced to each other by half a period and consist of metallic or semi-metallic (e.g. 70 nm ZnS) wires or trilayers.

Thus a subwavelength structure is known, having a ZnS coating of approx. 70 nm. Also these structures are suited only as a color filter in reflection. Hence the structure must additionally be applied onto a light-absorbent base surface to achieve a sufficient color contrast, which is then visible in reflection. Subwavelength gratings with metallic coatings show a relatively high color saturation in transmission. Because of the light absorption in the metal, they therefore appear relatively dark.

Sine gratings overlaid with a thin metal film can cause plasmonic resonance effects. These resonances lead to an elevated transmission in TM—polarization, cf. Y. Jorlin et al. “Spatially and polarization resolved plasmon mediated transmission through continuous metal films”; Opt. Express 17, 12155-12166 (2009). This effect can be optimized by an additional thin dielectric layer still, which is know, for example, from T. Tenev et al., “High Plasmonic Resonant Reflection and Transmission at Continuous Metal Films on Undulated Photosensitive Polymer”, Plasmonics (2013). A security element with such an optical effect is described, for example, in WO 2012/136777 A1.

In the print WO 2014/033324 A2 transmissive security elements are likewise described, which are based on subwavelength gratings and show an angular-dependent color. The optical properties of highly refractive coated sinusoidal gratings are discussed there in detail.

The known two-dimensional, periodic subwavelength gratings with non-contiguous surface indeed show color filter properties, yet have a great angular tolerance. Therefore, their color tone hardly changes upon tilting.

The invention is therefore based on the object is to state a security element that shows a good color effect in see-through which changes upon tilting.

This object is achieved according to the invention by a security element for manufacturing value documents, such as bank notes, checks or the like, which has: a dielectric substrate, embedded in the substrate a first line grating structure of several first grating ridges running along a longitudinal direction and arranged in a first plane, made of highly refractive dielectric or semi-metallic material, and embedded in the substrate a second line grating structure of second grating ridges, made of highly refractive dielectric or semi-metallic material, running along the longitudinal direction, which in respect to the first plane is located above the first line grating structure in a second plane, wherein the first grating ridges respectively have a first thickness and a first width and are lying side by side at a distance so that between the first grating ridges there are formed first grating grooves running along the longitudinal direction having a width corresponding to the distance, the second line grating structure is inverted to the first line grating structure, wherein in plan view of the first plane the second grating ridges have respectively a second thickness and lie above the first grating grooves and second grating groove, which exists between the second grating ridges, above the first grating ridges, and the width of the first grating ridges and the second grating grooves, the width of the second grating ridges and the first grating grooves is respectively less than 300 nm, wherein the security element generates a color effect in transmissive viewing and the first and the second thickness amount to at least 100 nm, preferably at least 150 nm.

The highly refractive material is preferably dielectric or a semiconductor, e.g. Si, Ge, C.

According to the invention a double line grating is used which consists of line grating structures constructed of two superposed planes, complementarily to each other, i.e. displaced relative to each other. A phase shift of 90° is the ideal value, which of course is to be seen within the scope of the production accuracy. Due to manufacturing tolerances, deviations from the complementarity, that is 90° phase shift, may arise here, because as a rule a rectangular profile cannot be configured perfectly, but rather only approximated by a trapezoid profile whose upper parallel edge is shorter than the lower one. With a periodic line grating structure, the phase shift corresponds to half a period.

The line grating structures are made of highly refractive dielectric or semi-metallic material. The thickness of the grating ridges is optionally lower than the modulation depth, that is less than the distance of the grating planes of the line grating structures. However, it can also be greater, so that a closed film is constituted. Then the distance of first and second plane is less than the sum of (0.5×first layer thickness) and (0.5×second layer thickness).

It has turned out that a grating constructed in such a way surprisingly delivers reproducible and well perceptible color effects in transmissive viewing upon tilting, in spite of the increased layer thickness.

The security element can be manufactured simply by a layer buildup, by first providing a base layer on which the first line grating structure is formed. Onto this one applies a dielectric intermediate layer, which covers the first line grating structure and is optionally thicker than the grating ridges of the first line grating structure. Onto this the displaced second line grating structure can then be formed, and a dielectric cover layer constitutes the closure of the substrate embedded in the line grating structure.

Alternatively, a subwavelength grating, which has a rectangular profile in cross section, can also be first configured in the dielectric substrate. If one vapor-deposits this with the highly refractive material perpendicularly, a layer arises on the plateaus and in the grooves, which constitute the first and second grating ridges. Thus one has the desired first and second grating ridges in different planes. They are contiguous if the thickness of the grating ridges is greater than the modulation depth of the rectangular profile of the previously structured dielectric substrate.

One obtains a particularly good color effect if the vertical distance between the first and the second grating ridges, that is the modulation depth of the structure, lies between 100 nm and 500 nm. For measuring the distance serve the two planes, which for example can be defined by the same-facing surfaces of the first and second line grating structure, i.e. for example from the lower side of the grating ridges or the upper side of the grating ridges. The vertical distance is of course to be measured perpendicular to the plane parallel, thus indicates the height difference between the same-directed surfaces of the grating bars.

Into consideration as a material for the grating ridges come all materials which have a higher refractive index than the surrounding substrate, i.e. material, in particular around at least 0.3 higher.

The security element with the double line grating shows an angular-dependent color filtering during transmissive viewing. This angle dependence is particularly striking if the grating lines are perpendicular to the light incidence plane. The color filtering can be employed to design multicolored motifs so that they change their color with the rotational position or show different effects upon tilting the plane. It is therefore preferred that in plan view onto the plane at least two regions are provided whose longitudinal directions of the line grating structures lie obliquely to each other, in particular are rectangular. Upon perpendicular viewing, such a motif can be designed in so that it has a uniform color and no further structure upon perpendicular viewing. If one now tilts this element, the color of one region, for example the background, will change differently than the color of the other region, for example a motif.

Of course embodiments with several differently arranged regions are also conceivable. Thus, for example, a development is provided which has several regions in the security element, wherein the regions differ from each other with respect to the position of the grating lines and/or grating period of the line grating structures. Motifs with different color effects in transmissive viewing can therefore be manufactured.

It will be appreciated that the features mentioned hereinabove and those to be explained hereinafter are usable not only in the stated combinations but also in other combinations or in isolation, without going beyond the scope of the present invention.

Hereinafter the invention will be explained more closely by way of example with reference to the attached drawings, which also disclose features essential to the invention. There are shown:

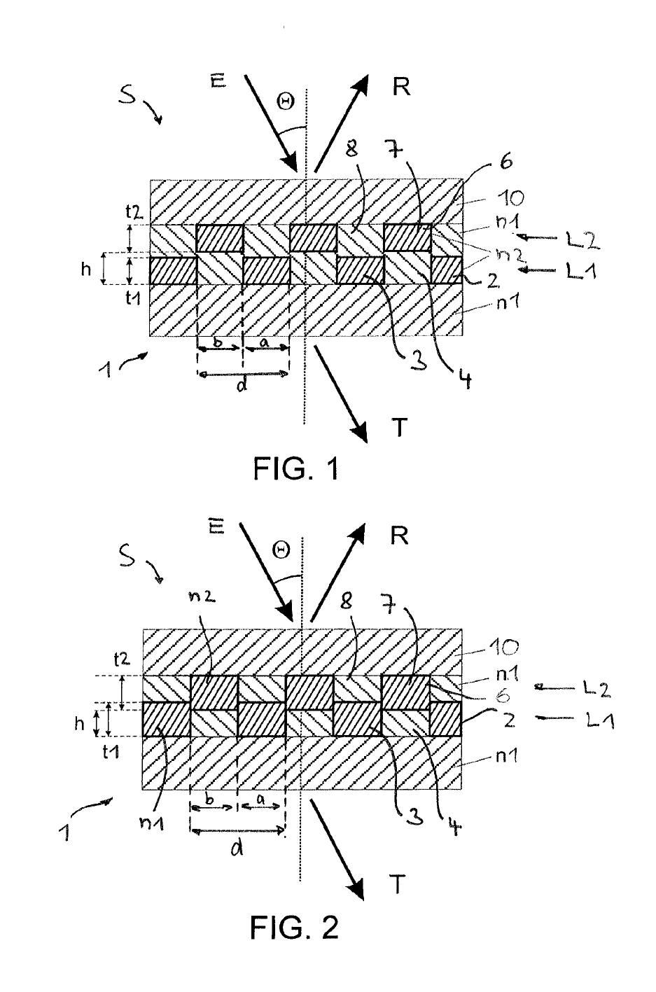

FIG. 1 a sectional representation of a security element with a double line grating in a first embodiment,

FIG. 2 a sectional representation of a security element with a double line grating in a second embodiment,

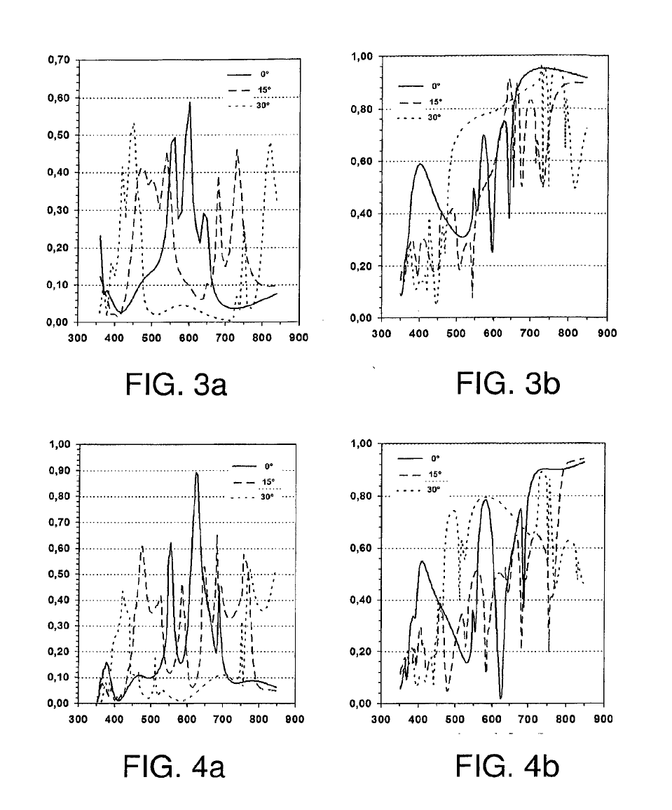

FIG. 3a-b the spectral dependence of the transmission and reflection of the security element of FIG. 1,

FIG. 4a-b the spectral dependence of the transmission and reflection of the security element of FIG. 2,

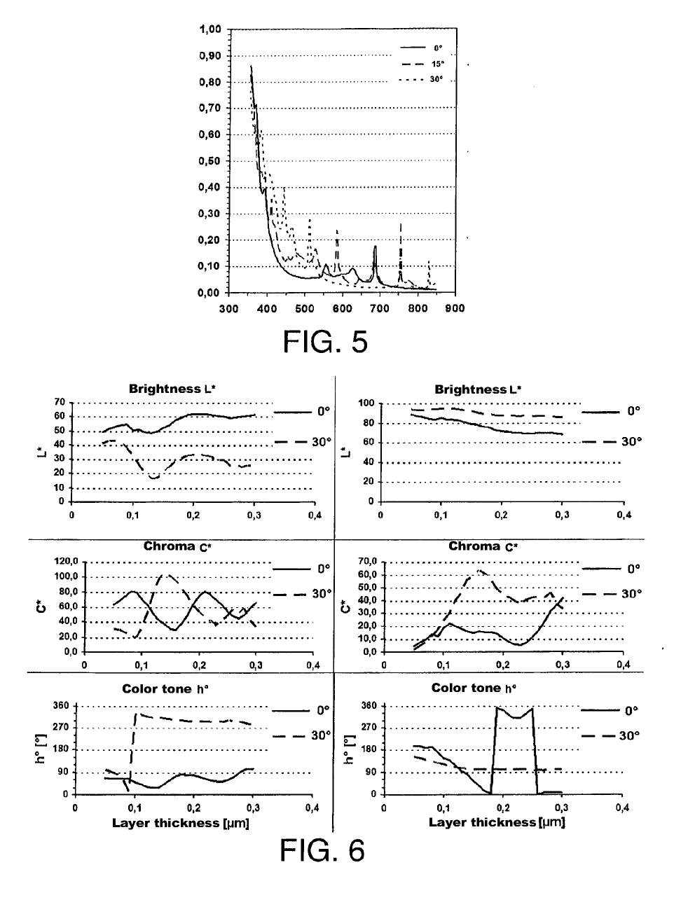

FIG. 5 the spectral dependence of the absorption of the security element of FIG. 2,

FIG. 6 color values in the LCh color space for reflection and transmission for the security element of FIG. 1 or 2 upon variation of a layer density,

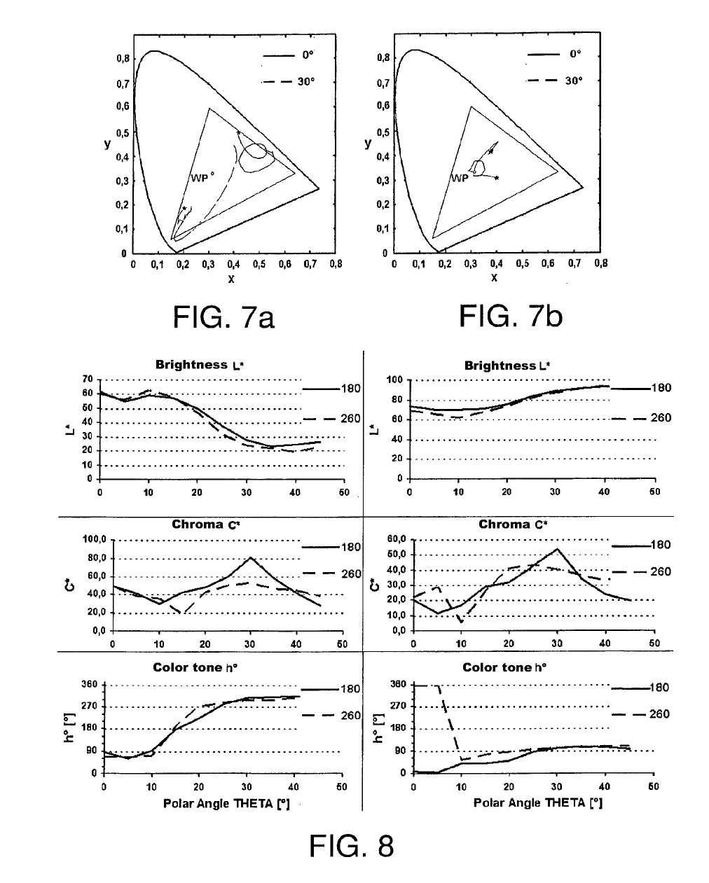

FIG. 7a-b a CIE 1931 color diagram for reflection and transmission of the security element of FIG. 1 or 2,

FIG. 8 color values in the LCh color space for reflection and transmission for the security elements of the FIGS. 1 and 2 upon variation of a viewing angle,

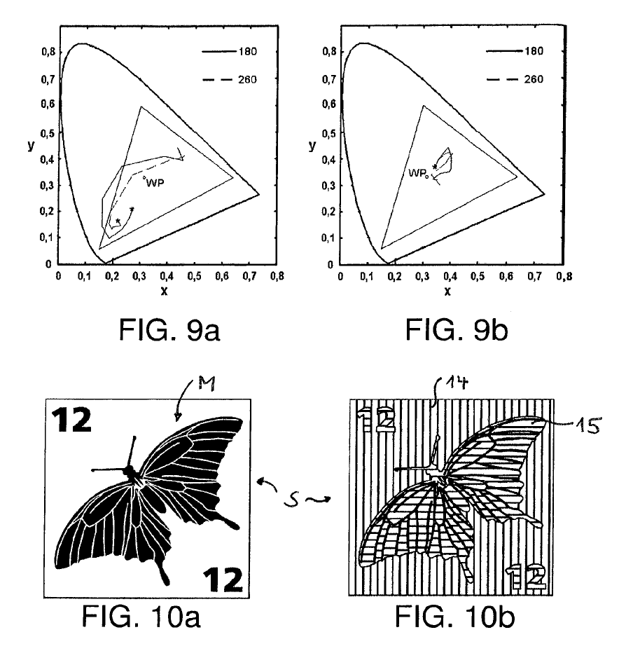

FIG. 9a-b a representation similar to FIG. 7 for two further embodiments of the security element,

FIG. 10a-b two plan views of a motif, which is formed as a security element with gratings of FIG. 1 or 2 in different orientations,

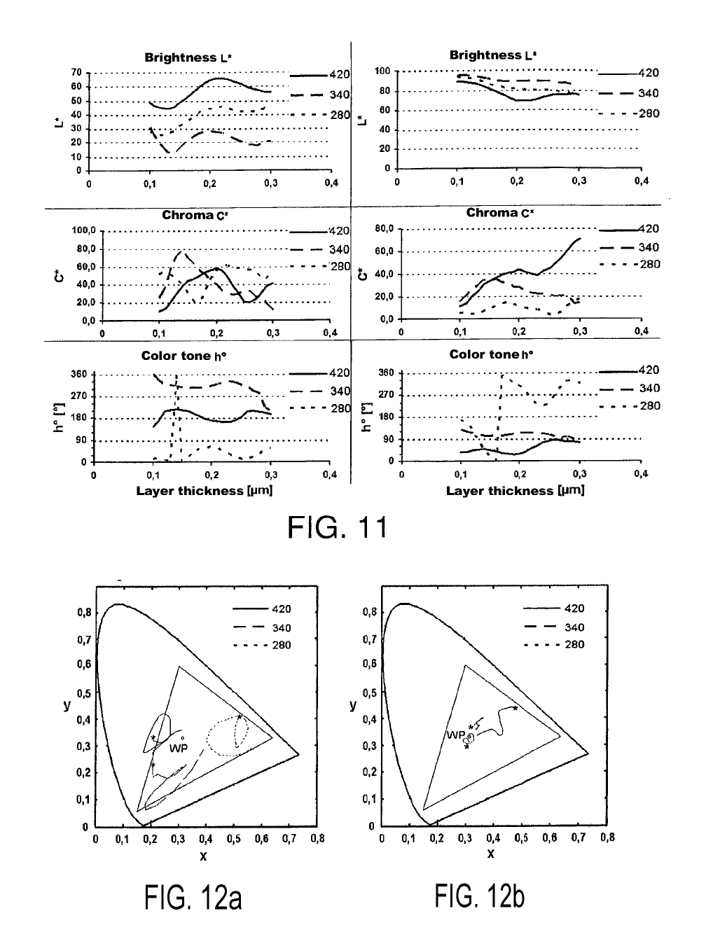

FIG. 11 color values in the LCh color space for reflection and transmission for further embodiments of the security element, with different grating periods,

FIG. 12a-b representations similar to FIG. 7a-b for further embodiments of the security element and

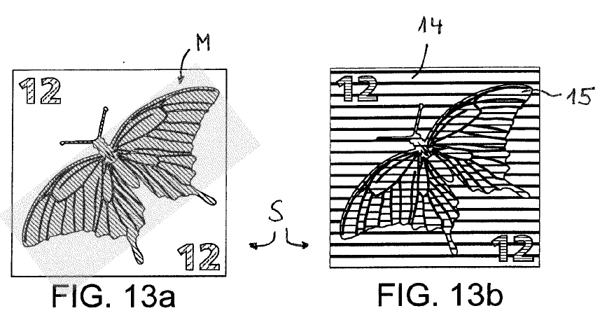

FIG. 13 representations like FIG. 10a-b a difference being that the individual regions are filled with gratings of different period.

FIG. 1 shows in sectional representation a security element S which has a double line grating, consisting of two line grating structures 2, 6, and is embedded in a substrate 1. The first line grating structure 2, which is arranged in a plane L1, is incorporated into the substrate 1. The first line grating structure 2 consists of the first grating ridges 9 with the width a, which extend along a longitudinal direction lying perpendicular to the drawing plane. Between the first grating ridges 3 are the first grating grooves 4, which have a width of b. The thickness of the first grating ridges 3 (measured perpendicularly to the plane L) is stated as t1. At a height h above the first grating ridges 3, the second line grating structure 6, having second grating ridges 7 with a thickness of t2, are located at a plane L2. These have the width b. The second line grating structure 6 is phase-shifted in the plane L2 against the first line grating structure 2 in such as way that the second grating ridges 7 comes to lie as precisely as possible (within the scope of the production accuracy) above the first grating grooves 4. Simultaneously the second grating grooves 8, which exist between the second grating ridges 7, lie above the first grating ridges 3.

The thickness t1 is smaller in the embodiment of FIG. 1 than the height h so that no contiguous film is formed by the grating ridges 3 and 7.

In the schematic sectional representation of FIG. 1, the width a of the first grating ridges 3 is equal to the width b of the second grating ridges 7. In relation to a period d, each line grating structure thus has the filling factor of 50%. This, however, is not mandatory. According to the formula b+a=d an arbitrary variation can be effected.

Also, in the schematic sectional representation of FIG. 1, the thickness t1 of the first grating ridges 2 is equal to the thickness t2 of the second grating ridges 7. This is of benefit to a simpler production, yet is not compulsory and t1≠t2 can apply. I in FIG. 1 is the modulation depth h, i.e. the height difference between the first line grating structure 2 and the second line grating structure 6 (according to the distance of the planes L1 and L2) is greater than the sum of the thicknesses of the first grating ridges 3 and the second grating ridges 7, so that a vertical separation is given between both line grating structures 2 and 6.

In the embodiment of the FIG. 2 there is a difference precisely here (and only there). In the embodiment of FIG. 2 thus results a contiguous film from the grating ridges 3 and 7. This is a first type.

The grating in FIG. 1 has a modulation depth which is greater than the wire height t1. This grating can be viewed as an arrangement of two wire gratings which have the same profile and are located at the distance h−t1 from each other. In contrast, the structure of FIG. 2 has a modulation depth which is smaller than the thickness t1. Hence the highly refractive structure there is spatially cohesive. This is a second type.

The grating ridges 3,7 in all embodiments are made of a highly refractive, dielectric or semi-metallic material. The highly refractive material has the refraction index n₂ and is surrounded by dielectrics. In practice these refractive indices of the surrounding material hardly differ and amount to approximately n₁. The refractive index n₂ of the highly refractive material lies above that (those) of the surrounding material, e.g. around at least 0.3 absolute.

The security element S of FIG. 1 reflects incident radiation E as a reflected radiation R. Further a radiation fraction is passed through as a transmitted radiation T. The reflection and transmission properties depend on the angle of incidence Θ, as to be explained hereinafter.

The production of the security element S can, for example, be effected by first applying to a base layer 9 the first line grating structure 2 and thereto an intermediate layer 5. Into the thus upward mapped second grating grooves 4 the second line grating structure having the second grating ridges 7 can then be incorporated. A cover layer 10 covers the security element. The refractive indices of the layers 9, 5 and 10 are substantially equal and can amount to, for example, about n1=1.5, in particular 1.56.

The measures b, a and t are in the subwavelength region, i.e. smaller than 300 nm. The modulation depth amounts to preferably between 100 nm and 500 nm.

However, a manufacturing method is also possible, wherein first a rectangular grating is manufactured on an upper side of the substrate 1. The substrate 1 is so structured that grooves of width a alternate with ridges of width b. The structured substrate is subsequently vaporized with the desired coating so that the first and second line gratings and the first and second line grating structures originate. After the vapor deposition, the structure is at last covered with a cover layer. There is thus obtained a layer buildup, wherein the upper side and lower side possess substantially the same refractive index.

The structured substrate can be obtained in different ways. One option is the reproduction using a master. The master can be replicated, e.g. now in UV lacquer on foil, e.g. PET foil. One then has the substrate 1 as a dielectric material which has, for example, a refractive index of 1.56. Alternatively, hot-stamping methods may also be used.

The master or also the substrate itself can be manufactured with the help of an e-beam system, a focused ion beam or through interference lithography, wherein the structure is written to a photoresist and subsequently developed.

In a following step the structure of a photolithographically manufactured master can be etched in a quartz substrate to form very perpendicular flanks of the profile. The quartz wafer then serves as a preform and can, e.g. be copied in Omocer or duplicated through galvanic molding. Likewise, a direct molding of the photolithographically manufactured original is possible in Omocer or in nickel in a galvanic method. Also, a motif with different grating structures can be composed in a nanoimprinting process starting out with a homogeneous grating master.

Such manufacturing methods for subwavelength grating structures and for motifs, consisting of different subwavelength structures, are known to the person skilled in the art.

Hereinafter the optical properties of both grating variants are discussed in an embodiment with grating ridges 3,7 made of the highly refractive material zinc sulfide (ZnS) and a substrate 1 made of polymer with n=1.52 in the visible wavelength region. It should be pointed out that ZnS is considered a dielectric, but has an absorption portion in the blue. It is further assumed that the profile geometry of the wires is rectangular. Small deviations from this rectangular form, such as a trapezoid form, lead to similar results in the optical effect of the grating.

FIGS. 3a and b show the computed spectral reflection as well as the transmission for a security element of the first type (FIG. 1) with the parameters d=360 nm, h=220 nm, b=180 nm and a ZnS coating having a thickness of t=180 nm. The incident light is unpolarized.

FIG. 3a shows on the y-axis the reflection as a function of the wavelength plotted to the x-axis for different angles of incidence, namely 0°, 15°, 30° and 45°. FIG. 3b shows analog the transmission. The angle of incidence Θ is defined in FIGS. 1 and 2.

The spectral reflection shows sharp peaks which can be found substantially as dips in the transmission spectra. For perpendicular incidence three peaks or dips are recognizable in the region of about 550 nm to 650 nm. For increasingly oblique angles of incidence, these resonances separate. One part is moved to the long-wave section, another part to the short-wave section. This shift can be derived approximately from the grating equation and there results therefrom the resonance wavelength λᵣ

λᵣ≅k(1±sin Θ₀).

The optical interaction of this grating can be described as so-called “guided mode resonance”. The grating acts as a light coupler and simultaneously as a waveguide. Such arrangements show electromagnetic resonances which are expressed as sharp peaks or as dips in the spectra.

The spectra for a security element of the second type (FIG. 2), thus having a contiguous highly refractive region, are represented in FIGS. 4a and b. For this grating the thickness amounts to t=260 nm. The spectra show a qualitatively similar pattern as in FIG. 3. However, the resonance at λ≅620 nm is distinctively more pronounced.

The spectral absorption for this grating is represented in FIG. 5. Here a strong absorption is recognizable in the UV and in the blue due to the relatively high k value of ZnS. Moreover, it turns out that the resonances cause sharp absorption peaks in the long wave region as well.

For examining the color properties of these security elements in the LCh color space, the computed transmission or reflection spectra were folded with the emission curve of a D65 standard light and the sensitivity of the human eye, and the color coordinates X, Y, Z were calculated. The D65 illumination corresponds roughly to daylight. Subsequently the XYZ coordinates were converted to the LCh color values.

These values can be associated directly with the human sensation upon color perception of a viewer:

L*: brightness,

C*: chroma (=color saturation) and

h°: color tone.

FIG. 6 shows the LCh color diagrams of a security element (on the left in reflection and on the right in transmission) with the parameters d=360 nm, h=210 nm, b=180 nm as a function of the thickness t1=t2=t of the ZnS coating for the angles of incidence Q=0° and 30°. Upon tilting the brightness or the chroma and the color tone vary distinctly in transmission for thicknesses greater than approx. 120 nm. The absorption effect of the semi-metallic ZnS (see FIG. 5) supports the chromaticity of the gratings in transmission described here. A purely dielectric coating without absorption portion would lead to a lower color saturation, however, would be possible as well.

FIG. 7 shows this effect in the CIE-1931 color space. The white point is marked “WP”. The triangle limits the color range which can usually be shown by monitors. In the diagram the x,y color coordinates are represented as trajectories. The endpoint of the thickness t=300 nm is marked with an asterisk. The color properties of the reflection are represented in FIG. 7a and the color diagram of the transmission in FIG. 7b. Here it is clearly recognizable that the color changes strongly upon tilting from 00 to 300 for gratings with increasing thickness t1=t2=t.

The color properties of a security element of the first or second type (with the thicknesses t1=t2=t=180 nm or 260 nm) as a function of the angle of incidence are shown in FIG. 8 in form of the values brightness, chroma and color tone.

For both types of the security elements, distinctly perceptible changes in color or intensity result in transmissive viewing upon tilting, as is recognizable in the appurtenant CIE 1931 color diagrams in FIG. 9.

Due to the fact that no color change occurs upon tilting perpendicularly to the plane of incidence, a security feature can be formed in such a way that a motif M is not to be seen in transmissive viewing and appears only upon tilting. This can be effected by arranging two regions 14,15 with the same grating profile rotated by 90° to each other.

This arrangement is shown in FIG. 10.

The grating lines of the region 14 forming the background run perpendicularly, whereas the grating lines in the region 15 forming the motif M run horizontally. When the security element is tilted around the horizontal axis, the motif M appears. Further orientations of regions are also conceivable. By finely gradating oriented regions, e.g. running effects in transmission can be created. Reference by way of example is made to DE 102011115589 A1. Now it is also possible to design motifs through regions having different profiles of the grating. The optical properties of gratings with different period show that embodiments with ZnS-coated gratings having the periods 420 nm, 340 nm and 280 nm represent the basic colors red, green, blue (RGB) in transmission upon the tilted viewing angle. FIG. 11 shows the brightness, chroma and color tone for these gratings as a function of the thickness of ZnS for the angle of incidence Θ=30°. The chroma increases distinctly with increasing thickness t>100 nm. An optimum lies at about t≅200 nm. For the grating having d=420 nm the red color can be configured even more distinctly through greater thicknesses t.

This is detectable even more clearly in the CIE color diagram (see FIG. 12). Here the endpoints t=300 nm are marked with an asterisk. For the reflection, these points lie approximately on the already explained color triangle. This is also the case for the grating with d=420 nm in transmission.

In embodiments these properties are utilized to generate colored motifs by arranging the above-described security elements with different grating periods in the region.

FIG. 13 shows schematically a security element S with a motif M which consists of three colors. These three regions are furnished with gratings of different period. Their grating lines are oriented horizontally. When viewed perpendicularly, the gratings show a weak color contrast. The motif can hardly be recognized. Upon tilting around the horizontal axis the motif appears in the three colors in a strong color tone.

The security element can serve as a see-through window in bank notes. It can also be partly overprinted in color. The highly refractive coating can also be partly removed, e.g. by laser irradiation with ultrashort pulses. Furthermore, a combination of highly refractive transparent holograms is possible. Such holograms can also act as reflection features. A part of the subwavelength grating can be located on an absorbent base surface so that this part now serves as a reflective feature and forms a contrast to the other part of the grating which lies in the region of the see-through window.

As mentioned, in the security element gratings having the corresponding profile parameters can render the basic colors RGB in transmission upon oblique angle of incidence. When viewed perpendicularly, however, the color saturation is weak. In reflection the grating structure appears almost in the colors complementary to the transmission.

It is known that true-color images can be generated by subwavelength grating.

The individual image pixels are rendered through subpixels, which correspond to the basic colors, e.g. RGB colors. Gratings with corresponding grating profile produce the desired color in the individual regions. Their area proportions are chosen in such a way that a viewer perceives each pixel as a mixed color of the subpixel regions. This method can also be applied for the gratings described here so that a true-color image is recognizable in transmission upon oblique viewing which almost disappears upon perpendicular viewing.

The security element can in particular serve as a see-through window in bank notes or other documents. It can also be partly overprinted in color or the grating regions can in some regions be demetallized or configured without line grating so that such a region is metallized completely. Combinations with diffractive grating structures, like holograms, are also conceivable.

### LIST OF REFERENCE SIGNS

1 Substrate
2 First line grating structure
3 First grating ridge
4 First grating groove
5 Intermediate layer
6 Second line grating structure
7 Second grating ridge
8 Second grating groove
9 Base layer
10 Cover layer
11, 13 Metal layer
12 Dielectric intermediate layer
14 Background
15 Motif
h Modulation depth
t, t1, t2 Coating thickness
b Line width
a Column width
d Period
S Security element
L1, L2 Plane
E Incident radiation
R Reflected radiation
T Transmitted radiation
Θ Angle of incidence

1-8. (canceled)

9. A security element for manufacturing value documents, such as bank notes, checks or the like, which has:
a dielectric substrate,
embedded in the substrate a first line grating structure of several first grating ridges made of highly refractive material running along a longitudinal direction and arranged in a first plane, and embedded in the substrate a second line grating structure of second grating ridges, made of highly refractive material, running along the longitudinal direction, which in respect to the first plane is located above the first line grating structure in a parallel second plane, wherein
the first grating ridges have respectively a first thickness and a first width and lie side by side at a distance so that between the first grating ridges there are formed first grating groove running along the longitudinal direction having a width corresponding to the distance,
the second line grating structure is inverted to the first line grating structure, wherein in plan view of the first plane the second grating ridges have respectively a second thickness and lie above the first grating grooves and second grating groove existing between the second grating ridges, above the first grating ridges, and
the width of the first grating ridges and of the second grating grooves, the width of the second grating ridges and of the first grating grooves is respectively less than 300 nm,
wherein
the security element generates a color effect in transmissive viewing and
the first and the second thickness amount to at least 100 nm.

10. The security element according to claim 9, wherein the highly refractive material has a refractive index which is at least 0.3 higher than that of the surrounding substrate.

11. The security element according to claim 9, wherein between the first plane of the first grating ridges and the plane of the second grating ridges there is a distance, which lies between 100 nm and 500 nm.

12. The security element according to claim 9, wherein the highly refractive material is selected from: ZnS, ZnO, ZnSe, SiNₓ, SiOₓ, Cr₂O₃, Nb₂O₅, Ta₂O₅, TiₓOₓ and ZrO₂.

13. The security element according to claim 9, wherein an average brightness or average chroma in transmissive viewing differs upon tilting of the security element by more than 10% from the corresponding value upon perpendicular passage of light.

14. The security element according to claim 9, wherein the first and the second line grating structure are periodical with a grating period and the security element in plan view of the plane has at least two regions whose grating periods differ.

15. The security element according to claim 9, which is configured as a see-through element, in particular as a window element for a value document.

16. A value document having a security element according to claim 9, wherein the value document has a window or a region provided for transmissive viewing, which window or region is covered by the security element.
